(19) United States
(12) Patent Application Publication
(10) Pub. No.: US 2008/0225855 A1
(43) Pub. Date: Sep. 18, 2008

(54) Method and system of auto-detecting network connecting mode

(75) Inventors: Tan-Chun Lu, Taipei County (TW); Li-Iu Chen, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/724,279

(22) Filed: Mar. 15, 2007

(51) Int. Cl. H04L 12/56

(52) U.S. Cl. 370/395.2

(57) ABSTRACT

An auto-detecting method for determining a network connecting mode between a client and a server. The client has a transmitting module, a receiving module and a determining module. The method includes a first detecting-packet transmitting process for enabling the transmitting module to transmit a first network-connecting-mode detecting packet to the server, a first determining process for determining whether or not the receiving module has received a first network-connecting-mode respond packet and thus deciding whether or not the network connecting mode is a first network connecting mode, a second detecting-packet transmitting process for enabling the transmitting module to transmit a second network-connecting-mode detecting packet to the server when the receiving module has not received the first network-connecting-mode respond packet, and a second determining process for determining that the network connecting mode is a second network connecting mode when the receiving module has received a second network-connecting-mode respond packet.

### BACKGROUND OF THE INVENTION

1. Field of Invention

The invention relates to a method of setting a network connecting mode and a system thereof, and, in particular, to a method and a system of auto-detecting a network connecting mode.

2. Related Art

In general, the main connecting modes for the broadband network are mainly classified into a PPPoE (Point-to-Point Protocol over Ethernet) connecting mode, a DHCP (Dynamic Host Configuration Protocol) connecting mode and a static IP address connecting mode. When the user wants to connect an electronic apparatus with a network, the electronic apparatus has to get a communication protocol between the electronic apparatus and a network accessing device or a network server. Thus, the user has to manually set the network connecting mode such that the electronic apparatus can be connected to the Internet and the network resource may be used.

However, different connecting modes need different parameters. The user who has understood and studied the network can set the parameters himself or herself. However, the user who is not familiar with the network cannot easily set various network connecting modes. Thus, the user, who is not familiar with the setting, often cannot correctly set the network connecting mode, thereby causing errors in setting the network connecting mode or disabling the electronic apparatus from the network. Alternatively, it is troublesome because the user may have to spend a lot of time to study how to set the network connecting mode.

Thus, it is an important subject of the invention to provide a method of setting the network connecting mode easily, and thus to shorten the time of setting the network connecting mode.

### SUMMARY OF THE INVENTION

In view of the foregoing, the invention is to provide a method and a system of auto-detecting a network connecting mode in order to shorten the wasted time, decrease the error, which occurs when the user, who is not familiar with the setting of the network connecting mode, sets the network connecting mode, and enhance the convenience.

To achieve the above, the invention discloses a method of auto-detecting a network connecting mode between a client and a server. The client has a transmitting module, a receiving module and a determining module. The method includes a first detecting-packet transmitting process, a first determining process, a second detecting-packet transmitting process and a second determining process.

In the invention, the first detecting-packet transmitting process enables the transmitting module to transmit a first network-connecting-mode detecting packet to the server. The first determining process determines whether or not the receiving module has received a first network-connecting-mode respond packet and thus determines whether or not the network connecting mode is a first network connecting mode. The second detecting-packet transmitting process enables the transmitting module to transmit a second network-connecting-mode detecting packet to the server when the receiving module has not received the first network-connecting-mode respond packet. The second determining process determines that the network connecting mode is a second network connecting mode when the receiving module has received a second network-connecting-mode respond packet.

In addition, the invention also provides a system of auto-detecting a network connecting mode between a client and a server. The system includes a transmitting module, a receiving module and a determining module. The transmitting module transmits a first network-connecting-mode detecting packet or a second network-connecting-mode detecting packet to the server. The receiving module receives a first network-connecting-mode respond packet or a second network-connecting-mode respond packet transmitted back from the server. The determining module receives the first network-connecting-mode respond packet or the second network-connecting-mode respond packet transmitted back from the server according to the receiving module, and thus decides that the network connecting mode is a first network connecting mode, a second network connecting mode or a static-IP-address connecting mode.

As mentioned above, the method and system according to the invention automatically detect the network connecting mode according to the network-connecting-mode detecting packet automatically transmitted from the client. Thus, it is possible to decrease the error, which occurs when the user is setting the network connecting mode, to shorten the setting time, and thus to enhance the convenience.

### BRIEF DESCRIPTION OF THE DRAWINGS

The invention will become more fully understood from the detailed description given herein below illustration only, and thus is not limitative of the present invention, and wherein:

FIG. 1A is a schematic illustration showing a system of auto-detecting a network connecting mode according to a preferred embodiment of the invention;

FIG. 1B is another schematic illustration showing the system of auto-detecting the network connecting mode according to the preferred embodiment of the invention; and

FIG. 2 is a flow chart showing a method of auto-detecting a network connecting mode according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

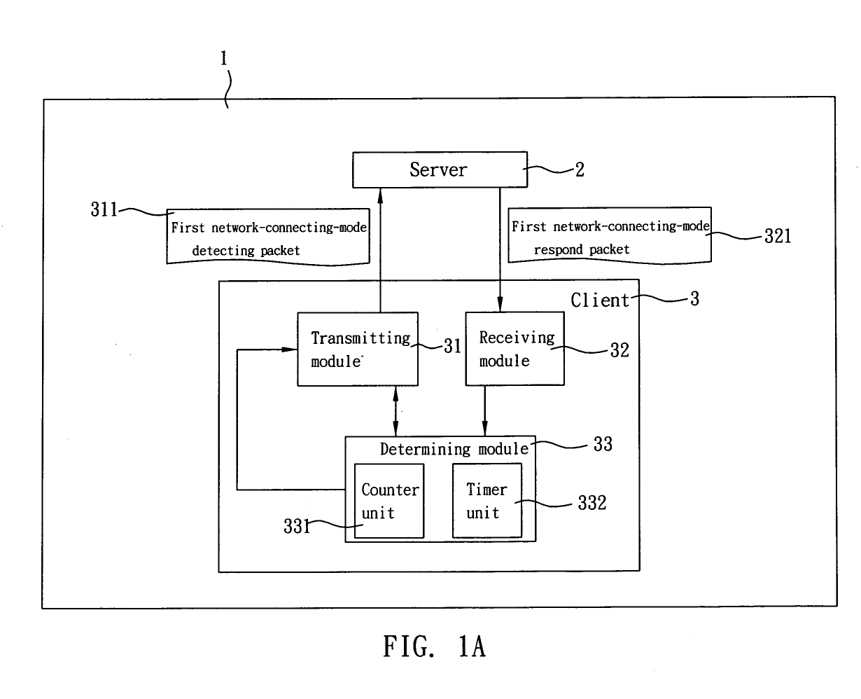

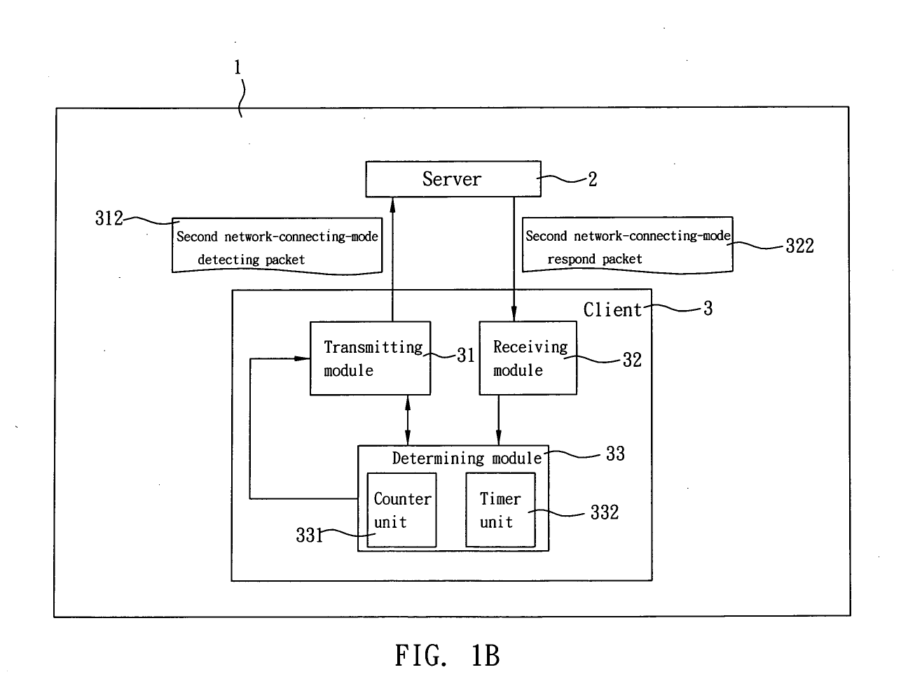

FIGS. 1A and 1B are schematic illustrations showing a system 1 of auto-detecting a network connecting mode according to a preferred embodiment of the invention. The system 1 includes a server 2 and a client 3. The client 3 includes a transmitting module 31, a receiving module 32 and a determining module 33.

The transmitting module 31 transmits a first network-connecting-mode detecting packet 311 (FIG. 1A) or a second network-connecting-mode detecting packet 312 (FIG. 1B) to the server 2.

The receiving module 32 receives a first network-connecting-mode respond packet 321 or a second network-connecting-mode respond packet 322 transmitted back from the server 2.

The determining module 33 decides that the network connecting mode is a first network connecting mode, a second network connecting mode or a static-IP-address connecting mode according to the first network-connecting-mode respond packet 321 or the second network-connecting-mode respond packet 322, which is transmitted back from the server 2 and received by the receiving module 32. Each of the first network connecting mode and the second network connecting mode may be a PPPoE (Point-to-Point Protocol over Ethernet) connecting mode or a DHCP (Dynamic Host Configuration Protocol) connecting mode.

In this embodiment, the determining module 33 may include a counter unit 331 and a timer unit 332. The counter unit 331 records the number of times that the transmitting module 31 transmits the first network-connecting-mode detecting packet 311 or the number of times that the transmitting module 31 transmits the second network-connecting-mode detecting packet 312. In addition, the timer unit 332 calculates a first waiting time period from the moment when the transmitting module 31 transmits the first network-connecting-mode detecting packet 311 to the moment when the receiving module 32 receives the first network-connecting-mode respond packet 321, or calculates a second waiting time period from the moment when the transmitting module 31 transmits the second network-connecting-mode detecting packet 312 to the moment when the receiving module 32 receives the second network-connecting-mode respond packet 322.

In the system 1 stated hereinabove, the first network-connecting-mode detecting packet 311 may be a PPPoE active discovery initiation frame, and the second network-connecting-mode detecting packet 312 may be a DHCP discovery frame. Of course, the first network-connecting-mode detecting packet 311 may also be the DHCP discovery frame, and the second network-connecting-mode detecting packet 312 may be the PPPoE active discovery initiation frame.

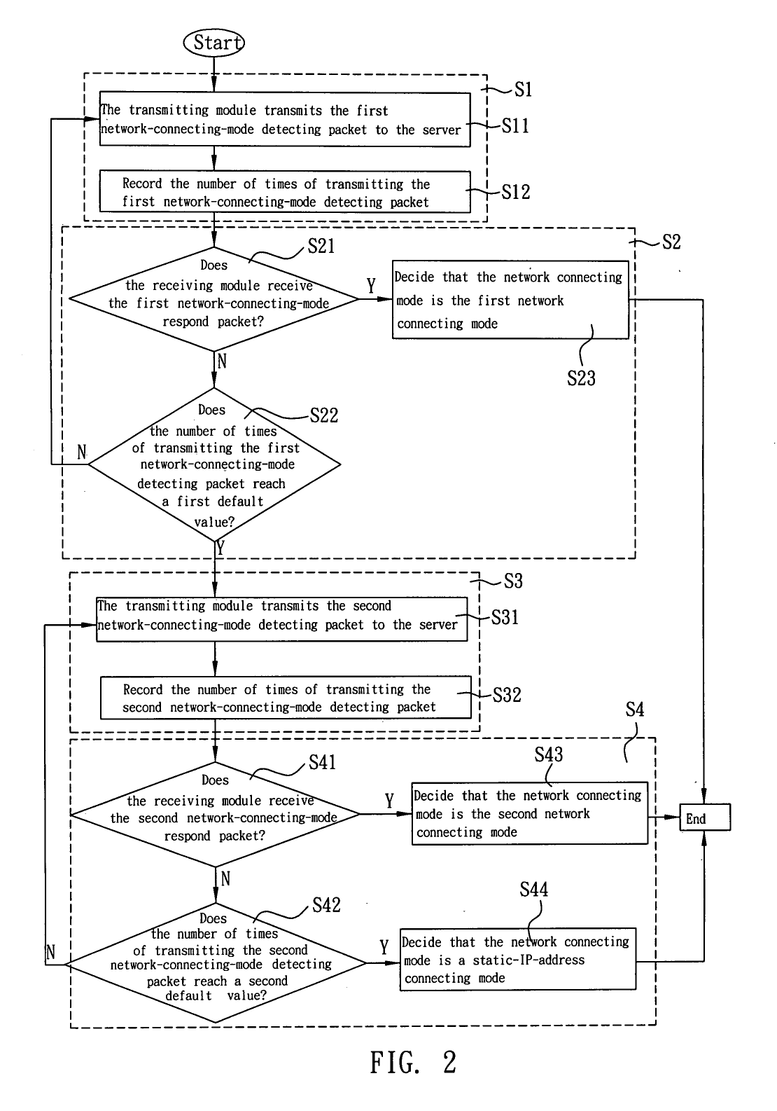

FIG. 2 is a flow chart showing a method of auto-detecting a network connecting mode according to another preferred embodiment of the invention. Referring to FIG. 2, the method determines a network connecting mode between a client and a server. The client has a transmitting module, a receiving module and a determining module. The method includes a first detecting-packet transmitting process S1, a first determining process S2, a second detecting-packet transmitting process S3 and a second determining process S4. In the following description, please also refer to FIGS. 1A and 1B.

The first detecting-packet transmitting process S1 includes steps S11 and S12. In step S11, the transmitting module 31 of the client 3 transmits the first network-connecting-mode detecting packet 311, which is a PPPoE active discovery initiation frame, to the server 2. Next, in step S12, the counter unit 331 adds 1 to the number of times that the transmitting module 31 transmits the first network-connecting-mode detecting packet 311, and records the number of times of transmitting the first network-connecting-mode detecting packet 311.

The first determining process S2 includes steps S21, S22 and S23. In step S21, the determining module 33 determines whether or not the receiving module 32 has received the first network-connecting-mode respond packet 321 within a first waiting time period, and thus decides whether or not the network connecting mode is a first network connecting mode. In this embodiment, when the receiving module receives the first network-connecting-mode respond packet 321 within the first waiting time period, as shown in step S23, it is decided that the network connecting mode is the first network connecting mode. When the receiving module 32 has not received the first network-connecting-mode respond packet 321 within a first default time period (e.g., 5 seconds) after the first waiting time period, as shown in step 22, it is further determined that whether or not the number of times of transmitting the first network-connecting-mode detecting packet 311 reaches a first default value, such as 3. Of course, the first default time period and the first default value can be adjusted according to the actual requirement. When the determining module 33 determines that the number of times of transmitting the first network-connecting-mode detecting packet 311 does not reach the first default value, the procedure goes back to step S11 of the first detecting-packet transmitting process Si. When the determining module 33 determines that the number of times of transmitting the first network-connecting-mode detecting packet 311 reaches the first default value, the second detecting-packet transmitting process S3 is performed.

It is to be noted that when no timer mechanism exists in the system 1, the receiving module 32 has to perform the second detecting-packet transmitting process S3 when it has not received the first network-connecting-mode respond packet 321 within the first default time period after the first waiting time period.

The second detecting-packet transmitting process S3 includes steps S31 and S32. In step S31, the transmitting module 31 of the client 3 transmits the second network-connecting-mode detecting packet 312, which is a DHCP discovery frame, to the server. Next, in step S32, the counter unit 331 adds 1 to the number of times that the transmitting module 31 transmits the second network-connecting-mode detecting packet 312 and records the number of times of transmitting the second network-connecting-mode detecting packet 312.

The second determining process S4 includes steps S41 to S44. In step S41, the determining module 33 determines whether or not the receiving module 32 has received the second network-connecting-mode respond packet 322 within a second waiting time period, and thus decides whether or not the network connecting mode is a second network connecting mode. In this embodiment, when the receiving module 32 receives the second network-connecting-mode respond packet 322 within the second waiting time period, as shown in step S43, it is decided that the network connecting mode is the second network connecting mode. When the receiving module 32 has not received the second network-connecting-mode respond packet 322 within a second default time period (e.g., 5 seconds) after the second waiting time period, as shown in step 42, it is further determined that whether or not the number of times of transmitting the second network-connecting-mode detecting packet 312 has reached a second default value, such as 3. Of course, the second default time period and the second default value may be adjusted according to the actual requirement. When the determining module 33 determines that the number of times of transmitting the second network-connecting-mode detecting packet 312 does not reach the second default value, the procedure goes back to step S31 of the second detecting-packet transmitting process S3. When the determining module 33 determines that the number of times of transmitting the second network-connecting-mode detecting packet 312 reaches the second default value, as shown in step S44, it is decided that the network connecting mode is a static-IP-address connecting mode.

In the method of auto-detecting the network connecting mode, the first network-connecting-mode detecting packet may also be the DHCP discovery frame, and the second network-connecting-mode detecting packet may also be the PPPoE active discovery initiation frame. The first determining process S2 determines whether or not the network connecting mode is the DHCP connecting mode, and the second determining process S4 determines whether the network connecting mode is the PPPoE connecting mode or the static-IP-address connecting mode.

In summary, the method and system according to the invention automatically detect the network connecting mode according to the network-connecting-mode detecting packet automatically transmitted from the client. Thus, it is possible to decrease the error, which occurs when the user is setting the network connecting mode, to shorten the setting time, and thus to enhance the convenience.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of auto-detecting a network connecting mode between a client and a server, the client having a transmitting module, a receiving module and a determining module, the method comprising:
a first detecting-packet transmitting process for enabling the transmitting module to transmit a first network-connecting-mode detecting packet to the server;
a first determining process for determining whether or not the receiving module has received a first network-connecting-mode respond packet and thus determining whether or not the network connecting mode is a first network connecting mode;
a second detecting-packet transmitting process for enabling the transmitting module to transmit a second network-connecting-mode detecting packet to the server when the receiving module has not received the first network-connecting-mode respond packet; and
a second determining process for determining that the network connecting mode is a second network connecting mode when the receiving module has received a second network-connecting-mode respond packet.

2. The method according to claim 1, wherein the first detecting-packet transmitting process further comprises:
recording a number of times that the transmitting module transmits the first network-connecting-mode detecting packet.

3. The method according to claim 2, wherein the first determining process comprises:
determining whether or not the number of times that the transmitting module transmits the first network-connecting-mode detecting packet reaches a first default value; and
performing the second detecting-packet transmitting process when the number of times reaches the first default value.

4. The method according to claim 3, wherein the first detecting-packet transmitting process is performed when the number of times does not reach the first default value.

5. The method according to claim 3, wherein the second detecting-packet transmitting process further comprises:
recording a number of times that the transmitting module transmits the second network-connecting-mode detecting packet.

6. The method according to claim 5, wherein the second determining process comprises:
determining whether or not the number of times that the transmitting module transmits the second network-connecting-mode detecting packet reaches a second default value; and
deciding that the network connecting mode is a static-IP-address connecting mode when the number of times reaches the second default value.

7. The method according to claim 6, wherein the second detecting-packet transmitting process is performed when the number of times does not reach the second default value.

8. The method according to claim 1, wherein the first determining process comprises:
calculating a first waiting time period from the moment when the transmitting module transmits the first network-connecting-mode detecting packet to the moment when the receiving module receives the first network-connecting-mode respond packet; and
performing the second detecting-packet transmitting process when the first waiting time period exceeds a first default time period.

9. The method according to claim 1, wherein the second determining process comprises:
calculating a second waiting time period from the moment when the transmitting module transmits the second network-connecting-mode detecting packet to the moment when the receiving module receives the second network-connecting-mode respond packet; and
deciding that the network connecting mode is a static-IP-address connecting mode when the second waiting time period exceeds a second default time period.

10. The method according to claim 9, wherein the second detecting-packet transmitting process is performed when the second waiting time period does not exceed the second default time period.

11. The method according to claim 1, wherein the first network-connecting-mode detecting packet or the second network-connecting-mode detecting packet is a PPPoE (Point-to-Point Protocol over Ethernet) active discovery initiation frame or a DHCP (Dynamic Host Configuration Protocol) discovery frame.

12. The method according to claim 1, wherein each of the first network connecting mode and the second network connecting mode is a communication-protocol connecting mode.

13. The method according to claim 12, wherein the communication-protocol connecting mode is a PPPoE (Point-to-Point Protocol over Ethernet) connecting mode or a DHCP (Dynamic Host Configuration Protocol) connecting mode.

14. A system of auto-detecting a network connecting mode between a client and a server, the system comprising:
a transmitting module for transmitting a first network-connecting-mode detecting packet or a second network-connecting-mode detecting packet to the server;
a receiving module for receiving a first network-connecting-mode respond packet or a second network-connecting-mode respond packet transmitted back from the server; and
a determining module for receiving the first network-connecting-mode respond packet or the second network-connecting-mode respond packet transmitted back from the server according to the receiving module, and thus deciding that the network connecting mode is a first network connecting mode, a second network connecting mode or a static-IP-address connecting mode.

15. The system according to claim 14, wherein the determining module comprises:
a counter unit for recording a number of times that the transmitting module transmits the first network-connecting-mode detecting packet or recording a number of times that the transmitting module transmits the second network-connecting-mode detecting packet; and
a timer unit for calculating a first waiting time period from the moment when the transmitting module transmits the first network-connecting-mode detecting packet to the moment when the receiving module. receives the first network-connecting-mode respond packet, or calculating a second waiting time period from the moment when the transmitting module transmits the second network-connecting-mode detecting packet to the moment when the receiving module receives the second network-connecting-mode respond packet.

16. The system according to claim 14, wherein the first network-connecting-mode detecting packet or the second network-connecting-mode detecting packet is a PPPoE (Point-to-Point Protocol over Ethernet) active discovery initiation frame or a DHCP (Dynamic Host Configuration Protocol) discovery frame.

17. The system according to claim 14, wherein each of the first network connecting mode and the second network connecting mode is a communication-protocol connecting mode.

18. The system according to claim 17, wherein the communication-protocol connecting mode is a PPPoE (Point-to-Point Protocol over Ethernet) connecting mode or a DHCP (Dynamic Host Configuration Protocol) connecting mode.
